(19) United States
(12) Patent Application Publication
(10) Pub. No.: US 2014/0055738 A1
(43) Pub. Date: Feb. 27, 2014

(54) Eyeglasses for Easy Fabrication

(71) Applicant: Anthony Wang Lee, Tainan City (TW)

(72) Inventor: Anthony Wang Lee, Tainan City (TW)

(21) Appl. No.: 13/591,369

(22) Filed: Aug. 22, 2012

(51) Int. Cl. G02C 5/14

(52) U.S. Cl. 351/121

(57) ABSTRACT

A pair of eyeglasses has a lens body, a frame, two temples and two endpieces. The lens body is formed integrally with two lenses and two engaging members. The frame is mounted detachably on the lens body and has two connecting sections. The temples are pivotally mounted respectively on the engaging members of the lens body. The endpieces pivotally fasten the temples respectively to the engaging members of the lens body. The lens body is formed into a single piece so that lenses are formed without being further fabricated on the rim member.

### BACKGROUND OF THE INVENTION

1. Field of the Invention

The present invention relates to a pair of glasses, and more particularly to a pair of eyeglasses that has lenses integrated onto a frame to simplify the fabrication and maintenance thereof.

2. Description of Related Art

Conventional eyeglasses are classified into framed type and frameless type. Furthermore, framed type eyeglasses are classified into full frame type and partial frame type.

With reference to FIG. 5, a pair of conventional framed type eyeglasses is assembled by a frame 30 and two lenses 40. The frame 30 has a rim set 31, two endpieces 32 and two temples 33.

The rim set 31 has two rim units 311, a bridge 312 and two nose pads 313. The rim units 311 are arranged at an interval. The bridge 312 is located between and connected to the rim units 311. The nose pads 313 are detachably screwed respectively on inner sides of the rim units 311 close to the bridge 312.

The endpieces 32 are screwed respectively on outer sides of the rim units 311 opposite to the bridge 312 to respectively hold the lenses 40 onto the rim units 311.

The temples 33 are detachably screwed respectively on the endpieces 32 and selectively pivot inward to change the eyeglasses into a folded configuration.

Assembling the aforementioned eyeglasses requires at least six tiny screws such that fabrication of the eyeglasses is complicated and time wasting.

To overcome the shortcomings, the present invention provides a pair of eyeglasses for easy fabrication to mitigate or obviate the aforementioned problems.

### SUMMARY OF THE INVENTION

The main objective of the invention is to provide a pair of eyeglasses that has lenses integrated onto a frame to simplify the fabrication and maintenance thereof.

A pair of eyeglasses in accordance with the present invention has a lens body, a frame, two temples and two endpieces. The lens body is formed integrally with two lenses and two engaging members. The frame is mounted detachably on the lens body and has two connecting sections. The temples are pivotally mounted respectively on the engaging members of the lens body. The endpieces pivotally fasten the temples respectively to the engaging members of the lens body. The lens body is formed into a single piece so that lenses are formed without being further fabricated on the rim member.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a pair of eyeglasses for easy fabrication in accordance with the present invention;

FIG. 2 is an enlarged partial perspective view of the eyeglasses in FIG. 1;

FIG. 3 is another enlarged partial perspective view of the eyeglasses in FIG. 1;

FIG. 4 is a perspective view of the eyeglasses in FIG. 1; and

FIG. 5 is a top view of a pair of conventional eyeglasses in accordance with the prior art.

### DETAILED DESCRIPTION OF THE PREFERRED EMBODIMENT

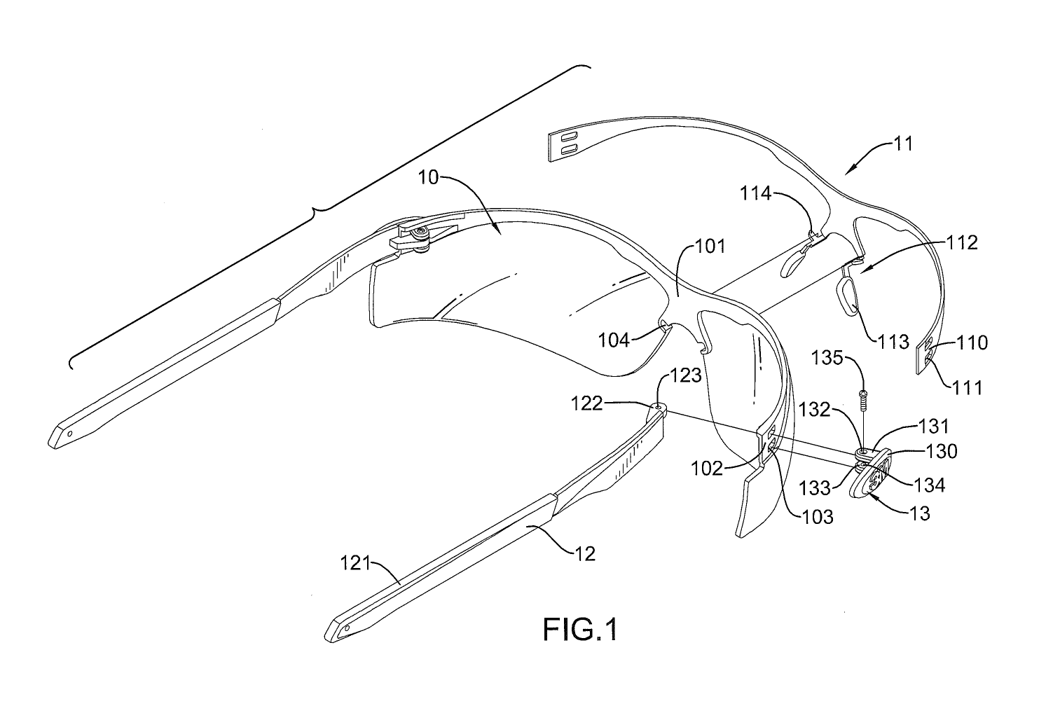

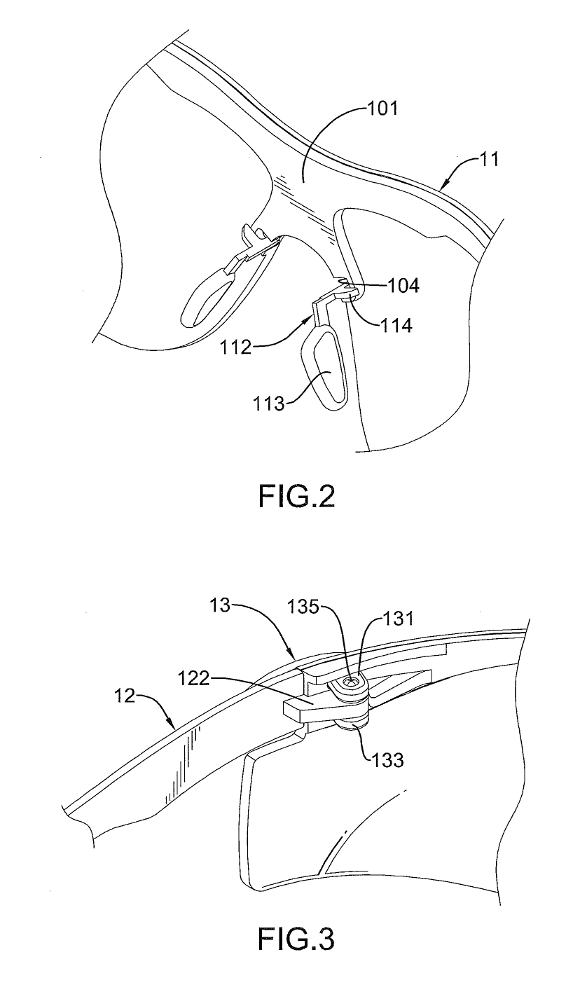

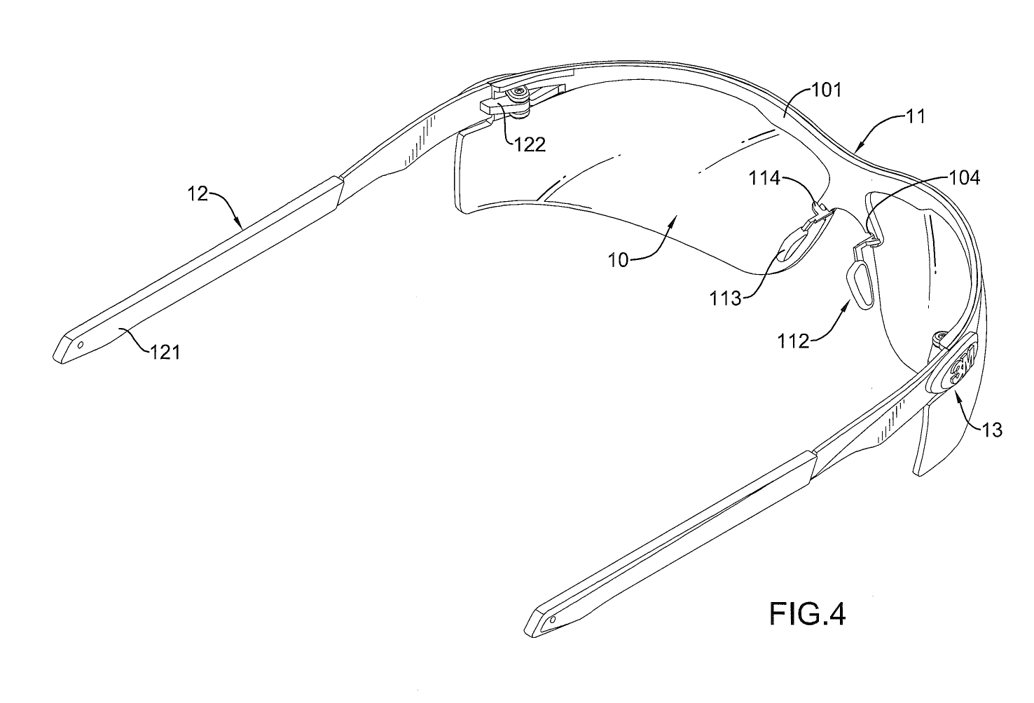

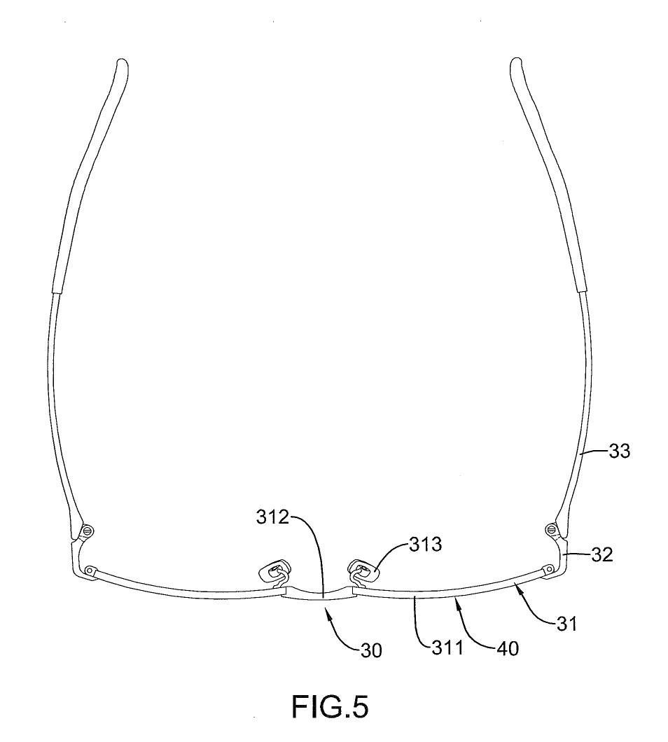

With reference to FIGS. 1 to 4, a pair of eyeglasses in accordance with the present invention comprises a lens body 10, a frame 11, two temples 12 and two endpieces 13.

The lens body 10 is formed into a single and undetachable piece and has a rim member 101, two lenses, two engaging members 102, two sets of through holes 103 and two mounting slots 104.

The rim member 101 has two bars and a bridge. Each bar has an outside end and an inside end. The bridge is formed integrally between the inside ends of the bars.

The lenses are integrally formed respectively on the bars of the rim member 101.

The engaging members 102 are formed respectively on the outside ends of the bars of the rim member 101.

The sets of through holes 103 are defined respectively through the engaging members 102.

The mounting slots 104 are defined through the bridge of the rim member 101.

The frame 11 is mounted detachably on and aligns with the rim member 101 of the lens body 10 and has two bar sections, a bridge section, two connecting sections 110, two sets of through bores 111, two nose pads 113 and two hooks 114.

Each bar section has an inside end and an outside end.

The bridge section is formed integrally between the inside ends of the bar sections.

The connecting sections 110 are formed respectively on the outside ends of the bar sections.

The sets of the through bores 111 are defined respectively through the connecting sections 110.

The nose pads 113 are mounted on the bridge section of the frame 11.

The hooks 114 protrude respectively from the nose pads 113 and hook respectively in the mounting slots 104 to stably position the frame 11 on the lens body 10.

The temples 12 are pivotally mounted respectively on and correspond to the engaging members 102 of the lens body 10. Each temple 12 has a connecting end, a free end, a pivot member 122 and a pivot hole 123. The free end is opposite to the connecting end. The pivot member 122 is formed on the connecting end and is mounted rotatably on a corresponding engaging member 102 of the lens body 10. The pivot hole 123 is defined through the pivot member 122.

The endpieces 13 correspond to the engaging members 102 of the lens body 10, the connecting sections 110 of the frame 11 and the temples 12, are mounted respectively through the engaging members 102 and the connecting sections and are pivotally connected respectively to the temples 12. Each endpiece 13 pivotally fastens a corresponding temple 12 to a corresponding engaging member 102 of the lens body and has a faceplate 130 and multiple fastening tabs 131.

The faceplate 130 is mounted on the corresponding engaging member 102 of the lens body 10 and may have decorative patterns or reliefs thereon.

The fastening tabs 131 are formed on and protrude from the faceplate 130, extend respectively through the through bores 111 of the corresponding connecting section 110 of the frame 11 and respectively through the through holes 103 of the corresponding engaging member 102 of the lens body 10 and are rotatably connected to the pivot member 122 of the corresponding temple 12. Each fastening tab 131 has a mounting hole 132 defined through the fastening tab 131 so that a fastener 135 such as a bolt or rivet extends through the mounting holes 132 of the fastening tabs 131 and the pivot hole 123 of the pivot member 122 to pivotally connect the endpiece 13 and the temple 12.

The lens body 10 is formed into a single piece so that lenses are formed without being further fabricated on the rim member 101. Furthermore, fabricating the glasses only needs two fasteners 135 so that fabrication or maintenance of the glasses is quick and efficient.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended

What is claimed is:

1. A pair of eyeglasses comprising:
a lens body formed into a single and undetachable piece and having:
a rim member having:
two bars and each bar having an outside end and an inside end; and
a bridge formed integrally between the inside ends of the bars;
two lenses integrally formed respectively on the bars of the rim member; and
two engaging members formed respectively on the outside ends of the bars of the rim member;
a frame mounted detachably on the lens body and having:
two bar sections and each bar section having an inside end and an outside end;
a bridge section formed integrally between the inside ends of the bar sections; and
two connecting sections formed respectively on the outside ends of the bar sections;
two temples pivotally mounted respectively on and corresponding to the engaging members of the lens body; and
two endpieces corresponding to the engaging members of the lens body, the connecting sections of the frame and the temples, mounted respectively through the engaging members and the connecting sections and pivotally connected respectively to the temples.

2. The pair of eyeglasses as claimed in claim 1, wherein
the lens body further has two sets of through holes defined respectively through the engaging members;
the frame further has two sets of through bores defined respectively through the connecting sections;
each temple has
a connecting end;
a free end;
a pivot member formed on the connecting end and mounted rotatably on a corresponding engaging member of the lens body; and
a pivot hole defined through the pivot member; and each endpiece has
a faceplate mounted on the corresponding engaging member of the lens body; and
multiple fastening tabs formed on and protruding from the faceplate, extending respectively through the through bores of the corresponding connecting section of the frame and respectively through the through holes of the corresponding engaging member of the lens body and rotatably connected to the pivot member of the corresponding temple, each fastening tab having a mounting hole defined through the fastening tab so that a fastener extends through the mounting holes of the fastening tabs and the pivot hole of the pivot member to pivotally connect the endpiece and the temple.

3. The pair of eyeglasses as claimed in claim 2, wherein the frame is mounted detachably on and aligns with the rim member of the lens body.

4. The pair of eyeglasses as claimed in claim 3, wherein
the lens body further has two mounting slots defined through the bridge of the rim member; and
the frame further has
two nose pads mounted on the bridge section of the frame; and
two hooks protruding respectively from the nose pads and hooking respectively in the mounting slots to stably position the frame on the lens body.
